(19) United States
(12) Patent Application Publication
(10) Pub. No.: US 2025/0239175 A1
(43) Pub. Date: Jul. 24, 2025

(54) Toilet Training Products and Formulations for Same

(71) Applicant: Brynne M. Moody, Valley City, OH (US)

(72) Inventor: Brynne M. Moody, Valley City, OH (US)

(21) Appl. No.: 18/986,132

(22) Filed: Dec. 18, 2024

Related U.S. Application Data
(60) Provisional application No. 63/612,004, filed on Dec. 19, 2023.

(51) Int. Cl. G09B 19/00

(52) U.S. Cl. CPC G09B 19/0076

(57) ABSTRACT

The present invention relates to toilet training products and various formulations for making same. In one embodiment, the toilet training products of the present invention are designed to be placed in a water-based environment including, but not limited to, a toilet or some other potty-training device and are designed to float on the surface of any water present therein and emit one or more fizzing actions, bubbling actions, and/or colors. In another embodiment, the toilet training products of the present invention are color-based and are designed to be placed in a water-based environment including, but not limited to, a toilet or some other potty-training device and are designed to float on the surface of any water present therein and emit one or more colors as well as react with any water present to produce a fizzing action (or reaction product) and/or a bubbling action (or reaction product).

### CROSS-REFERENCE TO RELATED APPLICATIONS

This application claims priority to and is a non-provisional of U.S. Patent Application No. 63/612,004, filed Dec. 19, 2024, the disclosure of which is hereby incorporated by reference in its entirety.

### FIELD OF THE INVENTION

The present invention relates to toilet training products and various formulations for making same. In one embodiment, the toilet training products of the present invention are designed to be placed in a water-based environment including, but not limited to, a toilet or some other potty-training device and are designed to float on the surface of any water present therein and emit one or more fizzing actions, bubbling actions, and/or colors. In another embodiment, the toilet training products of the present invention are color-based and are designed to be placed in a water-based environment including, but not limited to, a toilet or some other potty-training device and are designed to float on the surface of any water present therein and emit one or more colors as well as react with any water present to produce a fizzing action (or reaction product) and/or a bubbling action (or reaction product).

### BACKGROUND OF THE INVENTION

Toilet training children can be quite difficult especially when teaching a male child to urinate. A parent's biggest challenge is to persuade their child to use the toilet when they need to urinate. The next biggest challenge is to teach the child, particularly boys, to sanitarily use the toilet. Therefore, a toilet training device should merge amusement and fun with instructional value into one simple to use device.

Thus, there is a need in the art for a simple, interactive toilet training device that is both easy to use and provides sufficient feedback.

### SUMMARY OF THE INVENTION

The present invention relates to toilet training products and various formulations for making same. In one embodiment, the toilet training products of the present invention are designed to be placed in a water-based environment including, but not limited to, a toilet or some other potty-training device and are designed to float on the surface of any water present therein and emit one or more fizzing actions, bubbling actions, and/or colors. In another embodiment, the toilet training products of the present invention are color-based and are designed to be placed in a water-based environment including, but not limited to, a toilet or some other potty-training device and are designed to float on the surface of any water present therein and emit one or more colors as well as react with any water present to produce a fizzing action (or reaction product) and/or a bubbling action (or reaction product).

In one embodiment, the present invention relates to a toilet training product comprising: (i) at least one bicarbonate; (ii) at least one acid; (iii) at least one starch; and (iv) at least one low density additive, wherein the at least one low density additive has a density less than the density of water at 0° C. In another instance, this embodiment can be a color-based toilet training product that further comprises at least one color-containing compound.

In another embodiment, the present invention relates to a toilet training product comprising: (a) from at least about 30 weight percent to at least about 50 weight percent of at least one bicarbonate; (b) from at least about 20 weight percent to at least about 70 weight percent of at least one acid; (c) from at least about 5 weight percent to at least about 15 weight percent of at least one starch; and (d) from at least about 10 weight percent to at least about 30 weight percent of at least one low density additive, wherein the at least one low density additive has a density less than the density of water at 0° C. In another instance, this embodiment can be a color-based product that further comprises at least one color-containing compound.

In still another embodiment, the present invention relates to a toilet training product comprising: (I) from at least about 30 weight percent to at least about 50 weight percent of sodium bicarbonate; (II) from at least about 20 weight percent to at least about 40 weight percent of citric acid; (III) from at least about 5 weight percent to at least about 15 weight percent of at least one type of corn starch; and (IV) from at least about 10 weight percent to at least about 30 weight percent of at least one low density additive formed from one or more types of borosilicate microspheres, wherein the at least one low density additive has a density less than the density of water at 0° C. In another instance, this embodiment can be a color-based product that further comprises at least one color-containing compound.

In still another embodiment, the present invention relates to a toilet training product comprising: (I) about 40 weight percent of sodium bicarbonate; (II) about 30 weight percent of citric acid; (III) about 10 weight percent of at least one type of corn starch; and (IV) about 30 weight percent of at least one low density additive formed from one or more types of borosilicate microspheres, wherein the at least one low density additive has a density less than the density of water at 0° C. In another instance, this embodiment can be a color-based product that further comprises at least one color-containing compound.

### DETAILED DESCRIPTION OF THE INVENTION

The present invention relates to toilet training products and various formulations for making same. In one embodiment, the toilet training products of the present invention are designed to be placed in a water-based environment including, but not limited to, a toilet or some other potty-training device and are designed to float on the surface of any water present therein and emit one or more fizzing actions, bubbling actions, and/or colors. In another embodiment, the toilet training products of the present invention are color-based and are designed to be placed in a water-based environment including, but not limited to, a toilet or some other potty-training device and are designed to float on the surface of any water present therein and emit one or more colors as well as react with any water present to produce a fizzing action (or reaction product) and/or a bubbling action (or reaction product).

Given the above, in one embodiment the toilet training products of present invention are formed from a composition that is comprised of: (i) at least one bicarbonate; (ii) at least one acid; (iii) at least one starch; and (iv) at least one low density additive, wherein the at least one low density additive has a density less than the density of water at 0° C. In another instance, this embodiment can be a color-based product that further comprises at least one color-containing compound. It should be noted that the toilet training products of the present invention can be made into any desired three-dimensional shape. Suitable three-dimensional shapes include, but are not limited to, stars, one or more polygons, one squares or rectangles, one or more spheres or cylinders, or any other desired three-dimensional shape.

Regarding component (i), the at least one bicarbonate, suitable bicarbonates include, but are not limited to, one or more alkali-metal bicarbonates such as sodium bicarbonate (NaHCO₃), potassium bicarbonate (KHCO₃), and lithium bicarbonate (LiHCO₃); one or more alkali-earth bicarbonates such as magnesium bicarbonate (Mg(HCO₃)₂), calcium bicarbonate (Ca(HCO₃)₂); ammonium bicarbonate ((NH₄)HCO₃); one or more transition metal bicarbonates (e.g., Zn(HCO₃)₂, Cu(HCO₃)₂, CuHCO₃, etc.); or mixtures of any two or more thereof. It should be noted that although the formulas in this paragraph, as well as elsewhere in the specification, are given in anhydrous format, suitable hydrated versions of any of the compounds listed herein, if available, are also covered generically by any of the anhydrous formulas herein.

Regarding component (ii), the at least one acid, suitable acids include, but are not limited to, one or more inorganic acids, one or more organic acids, or mixtures of any two or more thereof. Suitable organic acids include, but are not limited to, lactic acid (CH₃CHCOOH), acetic acid (CH₃COOH), formic acid (HCOOH), citric acid (HOC(CH₂CO₂H)₂), oxalic acid (CO₂H)₂, uric acid (C₅H₄N₄O₃), malic acid (C₄H₆O₅), tartaric acid (C₄H₆O₆), or mixtures of any two or more thereof. Suitable inorganic acids include, but are not limited to, hydrochloric acid (HCl), nitric acid (HNO₃), phosphoric acid (H₃PO₄), sulfuric acid (H₂SO₄), boric acid (H₃BO₃), hydrofluoric acid (HF), hydrobromic acid (HBr), perchloric acid (HClO₄), hydroiodic acid (HI), or mixtures of any two or more thereof.

Regarding component (iii), the at least one starch, suitable starches include, but are not limited to, one or more types of corn starch, one or more types of potato starch, one or more types of wheat starch, one or more types of other vegetable starches (e.g., pea, soy, beet, squash, turnip, and/or lentil starches), one or more types of other grain starches (e.g., rice, oats, quinoa, bulgur, rye, barley, amaranth, millet, sorghum, triticale, and/or wild rice starches), or mixtures of any two or more thereof. In one non-limiting embodiment, the at least one starch of component (ii) can act as a binder to permit the formation of a suitable three-dimensional shape in order to achieve the desired toilet training products and/or color-based toilet training products of present invention and/or to act to bind together all of components (i) through (iv). In another embodiment, one or more other suitable binder compounds can be present in addition to, in combination with, or even in place of, component (ii).

Regarding component (iv), the at least one low density additive, suitable low density additives have a density less than the density of water at 0° C. (or less than about 0.997 g/ml) and include, but are not limited to, one or more types of borosilicate microspheres, one or more types of other glass microspheres, one or more types of polymer microspheres, or mixtures of any two or more thereof so long as the density of total amount of the at least one low density additive is below the density of water. Accordingly, some portion of the at least one low density additive might have a density greater than 1 g/ml.

In another embodiment, the total density of the at least one low density additive is less than about 0.98 g/ml, or less than about 0.95 g/ml, less than about 0.9 g/ml, less than about 0.85 g/ml, less than about 0.8 g/ml, less than about 0.75 g/ml, less than about 0.7 g/ml, less than about 0.65 g/ml, less than about 0.6 g/ml, less than about 0.55 g/ml, less than about 0.5 g/ml, less than about 0.45 g/ml, less than about 0.4 g/ml, less than about 0.35 g/ml, less than about 0.3 g/ml, less than about 0.25 g/ml, less than about 0.2 g/ml, less than about 0.15 g/ml, or even about 0.1 g/ml. Here, as well as elsewhere in the specification and claims, individual numerical values can be combined to form additional, or even new/non-disclosed, numerical ranges.

In one embodiment the amount of each component in the composition that is used to form the toilet training products and/or color-based toilet training products of present invention are selected from the following ranges: (i) from about 30 weight percent to about 50 weight percent of the at least one bicarbonate; (ii) from about 20 weight percent to about 70 weight percent of the at least one acid; (iii) from about 5 weight percent to about 15 weight percent of the at least one starch; and (iv) from about 10 weight percent to about 30 weight percent of the at least one low density additive, wherein the at least one low density additive has a density less than the density of water at 0° C., based on the total weight of components (i) through (iv) present. Although the total amount of each component (i) through (iv) may individually total more than 100 weight percent when each component is taken individually and totaled using the broadest amounts disclosed herein, one of skill in the art will realize that this is not the case. Rather, each individual component (i.e., components (i) through (iv)) of the various embodiments of the composition of the present invention can be varied within any stated range as desired in order to achieve a total weight percent of 100.

Regarding the amount of component (i) relative to the amount of component (ii), in one embodiment the amount of component (ii) should have enough acid moieties (e.g., H⁺ or —COOH) to be at least stoichiometrically equal to, or even stoichiometrically in excess of, the amount of bicarbonate moieties in the overall composition used to form the toilet training products and/or color-based toilet training products of present invention.

In another embodiment, the amount of component (i) (the at least one bicarbonate) in the overall composition used to form the toilet training products and/or color-based toilet training products of present invention is in the range of about 31 weight percent to about 49 weight percent, or from about 32 weight percent to about 48 weight percent, or from about 33 weight percent to about 47 weight percent, or from about 34 weight percent to about 46 weight percent, or from about 35 weight percent to about 45 weight percent, or from about 36 weight percent to about 44 weight percent, or from about 37 weight percent to about 43 weight percent, or from about 38 weight percent to about 42 weight percent, or from about 39 weight percent to about 41 weight percent, or even about 40 weight percent, based on the total weight of components (i) through (iv) present. Here, as well as elsewhere in the specification and claims, individual numerical values can be combined to form additional, or even new/non-disclosed, numerical ranges.

In another embodiment, the amount of component (ii) (the at least one acid) in the overall composition used to form the toilet training products and/or color-based toilet training products of present invention is in the range of about 21 weight percent to about 69 weight percent, or from about 22 weight percent to about 68 weight percent, or from about 23 weight percent to about 67 weight percent, or from about 24 weight percent to about 66 weight percent, or from about 25 weight percent to about 65 weight percent, or from about 26 weight percent to about 64 weight percent, or from about 27 weight percent to about 63 weight percent, or from about 28 weight percent to about 62 weight percent, or from about 29 weight percent to about 61 weight percent, or from about 30 weight percent to about 60 weight percent, of from about 31 weight percent to about 59 weight percent, or from about 32 weight percent to about 58 weight percent, or from about 33 weight percent to about 57 weight percent, or from about 34 weight percent to about 56 weight percent, or from about 35 weight percent to about 55 weight percent, or from about 36 weight percent to about 54 weight percent, or from about 37 weight percent to about 53 weight percent, or from about 38 weight percent to about 52 weight percent, or from about 39 weight percent to about 51 weight percent, or from about 40 weight percent to about 50 weight percent, of from about 41 weight percent to about 49 weight percent, or from about 42 weight percent to about 48 weight percent, or from about 43 weight percent to about 47 weight percent, or from about 44 weight percent to about 46 weight percent, or even about 45 weight percent, based on the total weight of components (i) through (iv) present. Here, as well as elsewhere in the specification and claims, individual numerical values can be combined to form additional, or even new/non-disclosed, numerical ranges.

In another embodiment, the amount of component (iii) (the at least one starch) in the overall composition used to form the toilet training products and/or color-based toilet training products of present invention is in the range of about 6 weight percent to about 14 weight percent, or from about 7 weight percent to about 13 weight percent, or from about 8 weight percent to about 12 weight percent, or from about 9 weight percent to about 11 weight percent, or even about 10 weight percent, based on the total weight of components (i) through (iv) present. Here, as well as elsewhere in the specification and claims, individual numerical values can be combined to form additional, or even new/non-disclosed, numerical ranges.

In another embodiment, the amount of component (iv) (the at least one low density additive) in the overall composition used to form the toilet training products and/or color-based toilet training products of present invention is in the range of about 11 weight percent to about 29 weight percent, or from about 12 weight percent to about 28 weight percent, or from about 13 weight percent to about 27 weight percent, or from about 14 weight percent to about 26 weight percent, or from about 15 weight percent to about 25 weight percent, or from about 16 weight percent to about 24 weight percent, or from about 17 weight percent to about 23 weight percent, or from about 18 weight percent to about 22 weight percent, or from about 19 weight percent to about 21 weight percent, or even about 20 weight percent, based on the total weight of components (i) through (iv) present. Here, as well as elsewhere in the specification and claims, individual numerical values can be combined to form additional, or even new/non-disclosed, numerical ranges.

In the embodiments where the toilet training product of the present invention is a color-based toilet training product, the present invention further includes component (v) at least one colorizing compound. Component (v) can be selected from any suitable colorant including, but not limited to, one or more powder-based colorants or dyes (be they individually water soluble or water insoluble), one or more liquid-based colorants or dyes (be they individually water soluble or water insoluble), or combinations of any two or more thereof. In one instance, the colorizing compound of the present invention is one or more water soluble powdered-based colorants, one or more water soluble liquid-based colorants, or a combination of any two or more thereof. In one embodiment, the amount of component (v) (the at least one colorizing compound) in the overall composition used to form the color-based toilet training products of present invention is in the range of about 0.01 weight percent to about 10 weight percent, based on the total weight of components (i) through (iv) present. It should be noted that where component (v) is present, the amount added to the overall composition of the present invention while being based on the total weight of components (i) through (iv) present is in addition thereto. That is, if components (i) through (iv) total 100 weight percent, the overall composition with component (v) being present therein is then in the range of 100.01 to 110 weight percent, based on the weight percents of components (i) through (iv).

In another embodiment, the amount of component (v) (the at least one colorizing compound) in the overall composition used to form the color-based toilet training products of present invention is in the range of about 0.02 weight percent to about 9.9 weight percent, or from about 0.03 weight percent to about 9.8 weight percent, or from about 0.04 weight percent to about 9.7 weight percent, or from about 0.05 weight percent to about 9.6 weight percent, or from about 0.06 weight percent to about 9.5 weight percent, or from about 0.07 weight percent to about 9.4 weight percent, or from about 0.08 weight percent to about 9.3 weight percent, or from about 0.09 weight percent to about 9.2 weight percent, or from about 0.1 weight percent to about 9.1 weight percent, or from about 0.2 weight percent to about 9 weight percent, or from about 0.3 weight percent to about 8.9 weight percent, or from about 0.4 weight percent to about 8.8 weight percent, or from about 0.5 weight percent to about 8.7 weight percent, or from about 0.6 weight percent to about 8.6 weight percent, or from about 0.7 weight percent to about 8.5 weight percent, or from about 0.8 weight percent to about 8.4 weight percent, or from about 0.9 weight percent to about 8.3 weight percent, or from about 1 weight percent to about 8.2 weight percent, or from about 1.1 weight percent to about 8.1 weight percent, or from about 1.25 weight percent to about 8 weight percent, or from about 1.5 weight percent to about 7.75 weight percent, or from about 1.75 weight percent to about 7.5 weight percent, or from about 2 weight percent to about 7.25 weight percent, or from about 2.25 weight percent to about 7 weight percent, or from about 2.5 weight percent to about 6.75 weight percent, or from about 2.75 weight percent to about 6.5 weight percent, or from about 3 weight percent to about 6.25 weight percent, or from about 3.25 weight percent to about 6 weight percent, or from about 3.5 weight percent to about 5.75 weight percent, or from about 3.75 weight percent to about 5.5 weight percent, or from about 4 weight percent to about 5.25 weight percent, or from about 4.25 weight percent to about 5 weight percent, or from about 4.5 weight percent to about 4.75 weight percent, or even about 4.6 weight percent, based on the total weight of components (i) through (iv) present. Here, as well as elsewhere in the specification and claims, individual numerical values can be combined to form additional, or even new/non-disclosed, numerical ranges. As noted above, in some embodiments the present invention includes no, or zero weight percent, colorizing compound.

It should be noted that in the clauses below, component (i) is also referred to as component (a) and component (I), component (ii) is also referred to as component (b) and component (II), component (iii) is also referred to as component (c) and component (III), component (iv) is also referred to as component (d) and component (IV), and component (v) is also referred to as component (e) and component (V), and the disclosures relating to any of the above component designations applies to all of the alternatively labeled components. That is, all of the disclosure herein relating to component (i) applies fully and equally to component (a) and component (I), all of the disclosure herein relating to component (ii) applies fully and equally to component (b) and component (II), all of the disclosure herein relating to component (iii) applies fully and equally to component (c) and component (III), all of the disclosure herein relating to component (iv) applies fully and equally to component (d) and component (IV), and all of the disclosure herein relating to component (v) applies fully and equally to component (e) and component (V).
Clause 1: A toilet training product comprising: (i) at least one bicarbonate; (ii) at least one acid; (iii) at least one starch; and (iv) at least one low density additive, wherein the at least one low density additive has a density less than the density of water at 0° C. In the instance where the toilet training product of this clause is a color-based toilet training product, the toilet training product further comprises (v) at least one colorizing compound.
Clause 2: The toilet training product or color-based toilet training product of clause 1, wherein the at least one bicarbonate is selected from one or more alkali-metal bicarbonates, one or more alkali-earth bicarbonates, ammonium bicarbonate ((NH₄)HCO₃), one or more transition metal bicarbonates, or mixtures of any two or more thereof.
Clause 3: The toilet training product or color-based toilet training product of clause 2, wherein the at least one bicarbonate is selected from sodium bicarbonate (NaHCO₃), potassium bicarbonate (KHCO₃), lithium bicarbonate (LiHCO₃), or mixtures of any two or more thereof.
Clause 4: The toilet training product or color-based toilet training product of clause 2, wherein the at least one bicarbonate is selected from magnesium bicarbonate (Mg(HCO₃)₂), calcium bicarbonate (Ca(HCO₃)₂), or mixtures of any two or more thereof.
Clause 5: The toilet training product or color-based toilet training product of clause 3, wherein the at least one bicarbonate is selected from sodium bicarbonate (NaHCO₃).
Clause 6: The toilet training product or color-based toilet training product of clause 1, wherein the at least one acid is selected from one or more inorganic acids, one or more organic acids, or mixtures of any two or more thereof.
Clause 7: The toilet training product or color-based toilet training product of clause 6, wherein the at least one acid is selected from lactic acid (CH₃CHCOOH), acetic acid (CH₃COOH), formic acid (HCOOH), citric acid (HOC(CH₂CO₂H)₂), oxalic acid (CO₂H)₂, uric acid (C₅H₄N₄O₃), malic acid (C₄H₆O₅), tartaric acid (C₄H₆O₆), or mixtures of any two or more thereof.
Clause 8: The toilet training product or color-based toilet training product of clause 6, wherein the at least one acid is selected from hydrochloric acid (HCl), nitric acid (HNO₃), phosphoric acid (H₃PO₄), sulfuric acid (H₂SO₄), boric acid (H₃BO₃), hydrofluoric acid (HF), hydrobromic acid (HBr), perchloric acid (HClO₄), hydroiodic acid (HI), or mixtures of any two or more thereof.
Clause 9: The toilet training product or color-based toilet training product of clause 7, wherein the at least one acid is selected from citric acid (HOC(CH₂CO₂H)₂).
Clause 10: The toilet training product or color-based toilet training product of clause 1, wherein the at least one starch is selected from one or more types of corn starch, one or more types of potato starch, one or more types of wheat starch, one or more types of other vegetable starches, one or more types of other grain starches, or mixtures of any two or more thereof.
Clause 11: The toilet training product or color-based toilet training product of clause 10, wherein the at least one starch is selected from one or more types of corn starch.
Clause 12: The toilet training product or color-based toilet training product of clause 1, wherein the at least one low density additive is selected from one or more types of borosilicate microspheres, one or more types of other glass microspheres, one or more types of polymer microspheres, or mixtures of any two or more thereof so long as the density of total amount of the at least one low density additive is below that of water.
Clause 13: The toilet training product or color-based toilet training product of clause 12, wherein the at least one low density additive is selected from one or more types of borosilicate microspheres.
Clause 14: A toilet training product comprising: (a) from at least about 30 weight percent to at least about 50 weight percent of at least one bicarbonate; (b) from at least about 20 weight percent to at least about 70 weight percent of at least one acid; (c) from at least about 5 weight percent to at least about 15 weight percent of at least one starch; and (d) from at least about 10 weight percent to at least about 30 weight percent of at least one low density additive, wherein the at least one low density additive has a density less than the density of water at 0° C. In the instance where the toilet training product of this clause is a color-based toilet training product, the toilet training product further comprises (e) at least one colorizing compound.
Clause 15: The toilet training product or color-based toilet training product of clause 14, wherein the at least one bicarbonate is selected from one or more alkali-metal bicarbonates, one or more alkali-earth bicarbonates, ammonium bicarbonate ((NH₄)HCO₃), one or more transition metal bicarbonates, or mixtures of any two or more thereof.
Clause 16: The toilet training product or color-based toilet training product of clause 15, wherein the at least one bicarbonate is selected from sodium bicarbonate (NaHCO₃), potassium bicarbonate (KHCO₃), lithium bicarbonate (LiHCO₃), or mixtures of any two or more thereof.
Clause 17: The toilet training product or color-based toilet training product of clause 15, wherein the at least one bicarbonate is selected from magnesium bicarbonate (Mg(HCO₃)₂), calcium bicarbonate (Ca(HCO₃)₂), or mixtures of any two or more thereof.
Clause 18: The toilet training product or color-based toilet training product of clause 16, wherein the at least one bicarbonate is selected from sodium bicarbonate (NaHCO₃).
Clause 19: The toilet training product or color-based toilet training product of clause 14, wherein the at least one acid is selected from one or more inorganic acids, one or more organic acids, or mixtures of any two or more thereof.
Clause 20: The toilet training product or color-based toilet training product of clause 19, wherein the at least one acid is selected from lactic acid (CH₃CHCOOH), acetic acid (CH₃COOH), formic acid (HCOOH), citric acid (HOC(CH₂CO₂H)₂), oxalic acid (CO₂H)₂, uric acid (C₅H₄N₄O₃), malic acid (C₄H₆O₅), tartaric acid (C₄H₆O₆), or mixtures of any two or more thereof.
Clause 21: The toilet training product or color-based toilet training product of clause 19, wherein the at least one acid is selected from hydrochloric acid (HCl), nitric acid (HNO₃), phosphoric acid (H₃PO₄), sulfuric acid (H₂SO₄), boric acid (H₃BO₃), hydrofluoric acid (HF), hydrobromic acid (HBr), perchloric acid (HClO₄), hydroiodic acid (HI), or mixtures of any two or more thereof.
Clause 22: The toilet training product or color-based toilet training product of clause 20, wherein the at least one acid is selected from citric acid (HOC(CH₂CO₂H)₂).
Clause 23: The toilet training product or color-based toilet training product of clause 14, wherein the at least one starch is selected from one or more types of corn starch, one or more types of potato starch, one or more types of wheat starch, one or more types of other vegetable starches, one or more types of other grain starches, or mixtures of any two or more thereof.
Clause 24: The toilet training product or color-based toilet training product of clause 23, wherein the at least one starch is selected from one or more types of corn starch.
Clause 25: The toilet training product or color-based toilet training product of clause 14, wherein the at least one low density additive is selected from one or more types of borosilicate microspheres, one or more types of other glass microspheres, one or more types of polymer microspheres, or mixtures of any two or more thereof so long as the density of total amount of the at least one low density additive is below that of water.
Clause 26: The toilet training product or color-based toilet training product of clause 25, wherein the at least one low density additive is selected from one or more types of borosilicate microspheres.
Clause 27: A toilet training product comprising: (I) from at least about 30 weight percent to at least about 50 weight percent of sodium bicarbonate; (II) from at least about 20 weight percent to at least about 40 weight percent of citric acid; (III) from at least about 5 weight percent to at least about 15 weight percent of at least one type of corn starch; and (IV) from at least about 10 weight percent to at least about 30 weight percent of at least one low density additive formed from one or more types of borosilicate microspheres, wherein the at least one low density additive has a density less than the density of water at 0° C. In the instance where the toilet training product of this clause is a color-based toilet training product, the toilet training product further comprises (V) at least one colorizing compound.
Clause 28: The toilet training product or color-based toilet training product of clause 27, wherein the composition comprises: (I) about 40 weight percent of sodium bicarbonate; (II) about 30 weight percent of citric acid; (III) about 10 weight percent of at least one type of corn starch; and (IV) about 30 weight percent of at least one low density additive formed from one or more types of borosilicate microspheres, wherein the at least one low density additive has a density less than the density of water at 0° C.
Clause 29: The toilet training product or color-based toilet training product of clause 28, wherein the density of the one or more types of borosilicate microspheres is less than 0.98 g/ml.
Clause 30: The toilet training product or color-based toilet training product of clause 28, wherein the density of the one or more types of borosilicate microspheres is less than 0.6 g/ml.

Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

What is claimed is:

1. A toilet training product comprising:
(i) at least one bicarbonate;
(ii) at least one acid;
(iii) at least one starch; and
(iv) at least one low density additive,
wherein the at least one low density additive has a density less than the density of water at 0° C., and
wherein the toilet training product optionally further comprises (v) at least one colorizing compound.

2. The toilet training product of claim 1, wherein the at least one bicarbonate is selected from one or more alkali-metal bicarbonates, one or more alkali-earth bicarbonates, ammonium bicarbonate ((NH₄)HCO₃), one or more transition metal bicarbonates, or mixtures of any two or more thereof.

3. The toilet training product of claim 2, wherein the at least one bicarbonate is selected from sodium bicarbonate (NaHCO₃), potassium bicarbonate (KHCO₃), lithium bicarbonate (LiHCO₃), or mixtures of any two or more thereof.

4. The toilet training product of claim 2, wherein the at least one bicarbonate is selected from magnesium bicarbonate (Mg(HCO₃)₂), calcium bicarbonate (Ca(HCO₃)₂), or mixtures of any two or more thereof.

5. The toilet training product of claim 3, wherein the at least one bicarbonate is selected from sodium bicarbonate (NaHCO₃).

6. The toilet training product of claim 1, wherein the at least one acid is selected from one or more inorganic acids, one or more organic acids, or mixtures of any two or more thereof.

7. The toilet training product of claim 6, wherein the at least one acid is selected from lactic acid (CH₃CHCOOH), acetic acid (CH₃COOH), formic acid (HCOOH), citric acid (HOC(CH₂CO₂H)₂), oxalic acid (CO₂H)₂, uric acid (C₅H₄N₄O₃), malic acid (C₄H₆O₅), tartaric acid (C₄H₆O₆), or mixtures of any two or more thereof.

8. The toilet training product of claim 6, wherein the at least one acid is selected from hydrochloric acid (HCl), nitric acid (HNO₃), phosphoric acid (H₃PO₄), sulfuric acid (H₂SO₄), boric acid (H₃BO₃), hydrofluoric acid (HF), hydrobromic acid (HBr), perchloric acid (HClO₄), hydroiodic acid (HI), or mixtures of any two or more thereof.

9. The toilet training product of claim 7, wherein the at least one acid is selected from citric acid (HOC(CH₂CO₂H)₂).

10. The toilet training product of claim 1, wherein the at least one starch is selected from one or more types of corn starch, one or more types of potato starch, one or more types of wheat starch, one or more types of other vegetable starches, one or more types of other grain starches, or mixtures of any two or more thereof.

11. The toilet training product of claim 10, wherein the at least one starch is selected from one or more types of corn starch.

12. The toilet training product of claim 1, wherein the at least one low density additive is selected from one or more types of borosilicate microspheres, one or more types of other glass microspheres, one or more types of polymer microspheres, or mixtures of any two or more thereof so long as the density of total amount of the at least one low density additive is below that of water.

13. The toilet training product of claim 12, wherein the at least one low density additive is selected from one or more types of borosilicate microspheres.

14. A toilet training product comprising:
(a) from at least about 30 weight percent to at least about 50 weight percent of at least one bicarbonate;
(b) from at least about 20 weight percent to at least about 70 weight percent of at least one acid;
(c) from at least about 5 weight percent to at least about 15 weight percent of at least one starch; and
(d) from at least about 10 weight percent to at least about 30 weight percent of at least one low density additive,
wherein the at least one low density additive has a density less than the density of water at 0° C., and
wherein the toilet training product optionally further comprises (e) at least one colorizing compound.

15. The toilet training product of claim 14, wherein the at least one bicarbonate is selected from one or more alkali-metal bicarbonates, one or more alkali-earth bicarbonates, ammonium bicarbonate ((NH₄)HCO₃), one or more transition metal bicarbonates, or mixtures of any two or more thereof.

16. The toilet training product of claim 15, wherein the at least one bicarbonate is selected from sodium bicarbonate (NaHCO₃), potassium bicarbonate (KHCO₃), lithium bicarbonate (LiHCO₃), or mixtures of any two or more thereof.

17. The toilet training product of claim 15, wherein the at least one bicarbonate is selected from magnesium bicarbonate (Mg(HCO₃)₂), calcium bicarbonate (Ca(HCO₃)₂), or mixtures of any two or more thereof.

18. The toilet training product of claim 16, wherein the at least one bicarbonate is selected from sodium bicarbonate (NaHCO₃).

19. The toilet training product of claim 14, wherein the at least one acid is selected from one or more inorganic acids, one or more organic acids, or mixtures of any two or more thereof.

20. The toilet training product of claim 19, wherein the at least one acid is selected from lactic acid (CH₃CHCOOH), acetic acid (CH₃COOH), formic acid (HCOOH), citric acid (HOC(CH₂CO₂H)₂), oxalic acid (CO₂H)₂, uric acid (CsHAN₄O₃), malic acid (C₄H₆O₅), tartaric acid (C₄H₆O₆), or mixtures of any two or more thereof.

21. The toilet training product of claim 19, wherein the at least one acid is selected from hydrochloric acid (HCl), nitric acid (HNO₃), phosphoric acid (H₃PO₄), sulfuric acid (H₂SO₄), boric acid (H₃BO₃), hydrofluoric acid (HF), hydrobromic acid (HBr), perchloric acid (HClO₄), hydroiodic acid (HI), or mixtures of any two or more thereof.

22. The toilet training product of claim 20, wherein the at least one acid is selected from citric acid (HOC(CH₂CO₂H)₂).

23. The toilet training product of claim 14, wherein the at least one starch is selected from one or more types of corn starch, one or more types of potato starch, one or more types of wheat starch, one or more types of other vegetable starches, one or more types of other grain starches, or mixtures of any two or more thereof.

24. The toilet training product of claim 23, wherein the at least one starch is selected from one or more types of corn starch.

25. The toilet training product of claim 14, wherein the at least one low density additive is selected from one or more types of borosilicate microspheres, one or more types of other glass microspheres, one or more types of polymer microspheres, or mixtures of any two or more thereof so long as the density of total amount of the at least one low density additive is below that of water.

26. The toilet training product of claim 25, wherein the at least one low density additive is selected from one or more types of borosilicate microspheres.

27. A composition comprising:
(I) from at least about 30 weight percent to at least about 50 weight percent of sodium bicarbonate;
(II) from at least about 20 weight percent to at least about 40 weight percent of citric acid;
(III) from at least about 5 weight percent to at least about 15 weight percent of at least one type of corn starch; and
(IV) from at least about 10 weight percent to at least about 30 weight percent of at least one low density additive formed from one or more types of borosilicate microspheres,
wherein the at least one low density additive has a density less than the density of water at 0° C., and
wherein the toilet training product optionally further comprises (V) at least one colorizing compound.

28. The composition of claim 27, wherein the composition comprises:
(I) about 40 weight percent of sodium bicarbonate;
(II) about 30 weight percent of citric acid;
(III) about 10 weight percent of at least one type of corn starch; and
(IV) about 30 weight percent of at least one low density additive formed from one or more types of borosilicate microspheres.

29. The composition of claim 28, wherein the density of the one or more types of borosilicate microspheres is less than 0.98 g/ml.

30. The composition of claim 28, wherein the density of the one or more types of borosilicate microspheres is less than 0.6 g/ml.
